(19) United States
(12) Patent Application Publication
(10) Pub. No.: US 2018/0130588 A1
(43) Pub. Date: May 10, 2018

(54) INDUCTOR AND METHOD FOR MANUFACTURING THE SAME

(71) Applicant: Shenzhen Sunlord Electronics Co., Ltd., Shenzhen (CN)

(72) Inventors: Youyun Li, Shenzhen (CN); Dafu Lu, Shenzhen (CN)

(21) Appl. No.: 15/861,698

(22) Filed: Jan. 4, 2018

Related U.S. Application Data
(63) Continuation of application No. PCT/CN2016/081203, filed on May 6, 2016.

(51) Int. Cl. H01F 17/06; H01F 27/32; H01F 41/12

(52) U.S. Cl. CPC H01F 17/062; H01F 2017/048; H01F 41/125; H01F 27/324

(57) ABSTRACT

An inductor and a method for manufacturing the same are disclosed. The inductor includes a magnetic body and a conductor coil, where the conductor coil is inside the magnetic body; and further includes an inorganic insulation layer, where the inorganic insulation layer is wrapped on a surface of the conductor coil, and the inorganic insulation layer is inside the magnetic body. According to the present application, an inductor having a higher inductance or an inductor having a lower direct current resistance may be manufactured.

### CROSS REFERENCE TO RELATED APPLICATIONS

This application is a continuation application of PCT/CN2016/081203, filed on May 6, 2016. The contents of PCT/CN2016/081203 are all hereby incorporated by reference.

### BACKGROUND OF THE INVENTION

### 1. Field of the Invention

The present application relates to an inductor and a method for manufacturing the same.

### 2. Description of the Prior Art

An inductor is used for stabilizing a current, storing energy, and filtering a spurious wave in a circuit. As one of parameters of the inductor, direct current resistance is an important indicator for measuring inductance quality.

In related art, a conducting wire of an inductor is usually embedded in a magnetic body, and a main component of the magnetic body is alloy powder having an adhesive. The conducting wire is wrapped by the alloy powder, then a forming pressure of 6 tons per square centimeter is applied, and heating is performed at a temperature not higher than 300° C. to solidify adhesion, so as to obtain the inductor.

### SUMMARY OF THE INVENTION

Researches show that because a conducting wire is usually an enameled copper wire, and the enameled copper wire can only withstand a relatively low temperature, that is, a temperature not higher than 600° C., a temperature of heating treatment on a magnetic body is limited to be not higher than 600° C. However, if heating treatment at a heating temperature of above 600° C. is performed on a formed magnetic body, the magnetic conductivity of the magnetic body may be increased by more than 20% compared with the magnetic conductivity before the heating treatment. It means that, for a same conducting wire structure, an inductance of an inductor that has been subject to heating treatment at a heating temperature of above 600° C. is more than 20% greater than that of an inductor on which heating treatment is not performed. An inductance of an inductor is directly related to a quantity of turns of a conductor, and a larger quantity of turns indicates a higher inductance and a higher direct current resistance. Therefore, it means that, for a same inductance, a smaller quantity of turns of the inductor that has been subject to heating treatment at a heating temperature of above 600° C. indicates a lower direct current resistance. However, in the prior art, the enameled copper wire is used. Consequently, a requirement for the heating treatment at a heating temperature of above 600° C. cannot be satisfied.

The present application provides an inductor and a method for manufacturing the same.

An inductor includes a magnetic body and a conductor coil, where the conductor coil is inside the magnetic body; and further includes an inorganic insulation layer, where the inorganic insulation layer is wrapped on a surface of the conductor coil, and the inorganic insulation layer is inside the magnetic body.

Preferably, the magnetic body is made of one of Fe—Si—Cr alloy, Fe—Ni alloy, Fe—Si alloy, Fe—Al alloy, Fe—Si—Al alloy, and amorphous alloy.

Preferably, the inorganic insulation layer is made of one of ceramic, glass, and a mixture of ceramic and glass.

Preferably, the conductor coil is made of one of copper, nickel, silver, and gold.

The present application further provides a method for manufacturing an inductor, including the following steps:

S1. mixing an organic adhesive and an inorganic insulation material to obtain a mixture;

S2. coating the mixture on a surface of a conducting wire;

S3. winding the conducting wire with the mixture on the surface to obtain a coil;

S4. embedding the coil into a magnetic body material, and applying a forming pressure to the magnetic body material; and

S5. performing heating treatment on the magnetic body material at a heating temperature of above 600° C., where the organic adhesive is volatilized after the heating, and the inorganic insulation material is wrapped on the surface of the conducting wire.

Preferably, the heating temperature ranges from 600° C. to 1000° C.

Preferably, the forming pressure ranges from 5 tons per square centimeter to 25 tons per square centimeter.

Preferably, the organic adhesive is a resin adhesive.

Preferably, the magnetic body material is one of Fe—Si—Cr alloy, Fe—Ni alloy, Fe—Si alloy, Fe—Al alloy, Fe—Si—Al alloy, and amorphous alloy.

Preferably, the inorganic insulation material is one of ceramic, glass, and a mixture of ceramic and glass.

According to the present application, the conducting wire embedded in the magnetic body material can withstand heating treatment at a heating temperature of above 600° C., so that the magnetic conductivity of the magnetic body material that has been subject to heating treatment at a heating temperature of above 600° C. is higher. Therefore, when a length of a conducting wire is specified, an inductor having a greater inductance can be manufactured. Alternatively, when an inductance is specified, only a shorter conducting wire is needed, so that an inductor having a lower direct current resistance can be manufactured.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an appearance of an inductor;

FIG. 2 is a planar perspective view of an inductor;

FIG. 3 is a sectional view of an inductor; and

FIG. 4 is a schematic sectional view of a conducting wire in an inductor.

### DETAILED DESCRIPTION

The following further describes exemplary embodiments of the present application in detail.

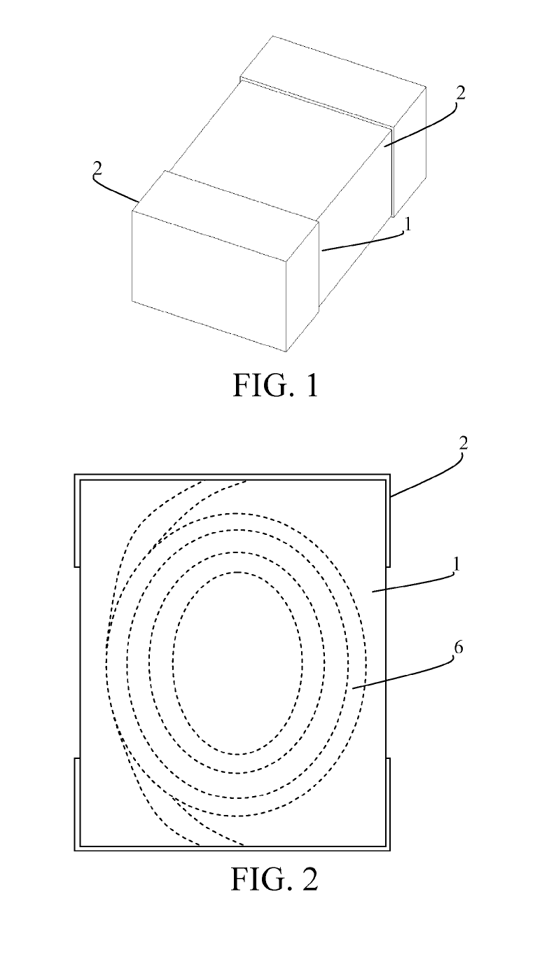

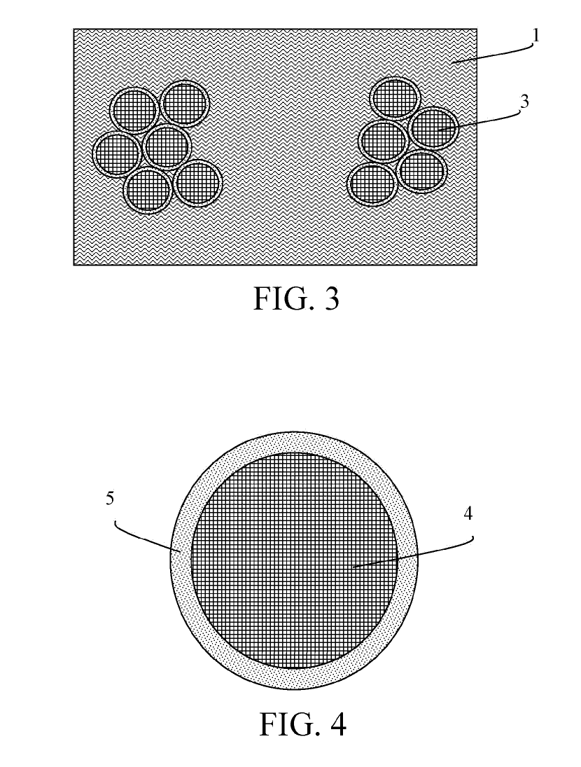

As shown in FIG. 1 to FIG. 4, in an embodiment, a method for manufacturing an inductor includes the following steps:

S1. Mix an organic adhesive and an inorganic insulation material to obtain a mixture.

The organic adhesive maybe a resin adhesive, and the inorganic insulation material may be ceramic, glass, or a mixture of ceramic and glass. In the mixture, an inorganic insulation material 5 is dispersed in the resin adhesive.

S2. Coat the mixture on a surface of a conducting wire.

A material of a conducting wire 4 maybe a material having good conductivity, such as copper, nickel, silver, or gold. The inorganic insulation material is adhered to the conducting wire 4 by using an organic adhesive.

S3. Wind the conducting wire with the mixture on the surface to obtain a coil.

As shown in FIG. 2, the conducting wire 4 is wound by using a winding device, to form a coil 6 having a specific coil structure.

S4. Embed the coil into a magnetic body material, and apply a forming pressure to the magnetic body material.

The coil 6 is embedded into a magnetic body material 1, and a pressure ranging from 5 tons per square centimeter to 25 tons per square centimeter is applied, to increase the density of the magnetic body material 1. An amount of the organic adhesive may be mixed into the magnetic body material, to assist forming.

S5. Perform heating treatment on the magnetic body material at a heating temperature of above 600° C., where the organic adhesive is volatilized after the heating, and the inorganic insulation material is wrapped on the surface of the conducting wire.

A maximum temperature of the heating treatment ranges from 600° C. to 1000° C., and the heating treatment may be performed in an atmosphere of air, nitrogen, hydrogen, or the like. In a process of the heating treatment, resin in the conducting wire and resin in the magnetic body material are decomposed and volatilized first. Being capable of withstanding a high temperature, the inorganic insulation material 5 on the surface of the conducting wire remains on the surface of the conducting wire 4 after the heating treatment, so that turns of the conducting wire are spaced from each other.

Compared with a magnetic body material that is treated at a temperature of below 600° C. and is used in the prior art, the magnetic conductivity of the magnetic body material 1 that has been subject to heating treatment can be effectively increased.

S6. Manufacture an external electrode in a manner such as silver soaking, electroplating, or chemical plating, so as to connect the internal coil and the external electrode.

Although the present application is described above in further detailed description through specific preferred implementations, the present application is not limited to the specific preferred implementations. It should be understood by persons of ordinary skill in the art that any simple deduction or replacement made without departing from the concept of the present application shall fall within the protection scope of the claims of the present application.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An inductor, comprising a magnetic body and a conductor coil, wherein the conductor coil is inside the magnetic body; and further comprising an inorganic insulation layer, wherein the inorganic insulation layer is wrapped on a surface of the conductor coil, and the inorganic insulation layer is inside the magnetic body.

2. The inductor according to claim 1, wherein the magnetic body is made of one of Fe—Si—Cr alloy, Fe—Ni alloy, Fe—Si alloy, Fe—Al alloy, Fe—Si—Al alloy, and amorphous alloy.

3. The inductor according to claim 1, wherein the inorganic insulation layer is made of one of ceramic, glass, and a mixture of ceramic and glass.

4. The inductor according to claim 1, wherein the conductor coil is made of one of copper, nickel, silver, and gold.

5. A method for manufacturing the inductor according to claim 1, comprising the following steps:
S1. mixing an organic adhesive and an inorganic insulation material to obtain a mixture;
S2. coating the mixture on a surface of a conducting wire;
S3. winding the conducting wire with the mixture on the surface to obtain a coil;
S4. embedding the coil into a magnetic body material, and applying a forming pressure to the magnetic body material; and
S5. performing heating treatment on the magnetic body material at a heating temperature of above 600° C., wherein the organic adhesive is volatilized after the heating, and the inorganic insulation material is wrapped on the surface of the conducting wire.

6. The method for manufacturing the inductor according to claim 5, wherein the heating temperature ranges from 600° C. to 1000° C.

7. The method for manufacturing the inductor according to claim 5, wherein the forming pressure ranges from 5 tons per square centimeter to 25 tons per square centimeter.

8. The method for manufacturing the inductor according to claim 5, wherein the organic adhesive is a resin adhesive.

9. The method for manufacturing the inductor according to claim 5, wherein the magnetic body material is one of Fe—Si—Cr alloy, Fe—Ni alloy, Fe—Si alloy, Fe—Al alloy, Fe—Si—Al alloy, and amorphous alloy.

10. The method for manufacturing the inductor according to claim 5, wherein the inorganic insulation material is one of ceramic, glass, and a mixture of ceramic and glass.
